(19) United States
(12) Patent Application Publication
(10) Pub. No.: US 2017/0309258 A1
(43) Pub. Date: Oct. 26, 2017

(54) ELECTRIC GUITAR / BASS WITH DOUBLE NECK, WHICH IS DIVIDED INTO TWO SEPARATE

(71) Applicant: Christoforos KANAKIS, Attiki (GR)

(72) Inventor: Christoforos KANAKIS, Attiki (GR)

(21) Appl. No.: 15/509,861

(22) PCT Filed: Sep. 9, 2015
(86) PCT No.: PCT/GR2015/000044

§ 371 Date: Mar. 9, 2017

(30) Foreign Application Priority Data
Sep. 17, 2014 (GR) 20140100467

(51) Int. Cl. G10D 1/08; G10D 3/06

(52) U.S. Cl. CPC G10D 1/085; G10D 3/06

(57) ABSTRACT

Electric guitar/bass with double neck, which can be divided into two separate autonomous guitars/bass (FIG. 1).

This division is made possible thanks to the special guitar/bass body composed by two individual bodies, mate and held together by screws or clips.

The advantage of such an invention is the possibility of multiple ‘3 in 1’ use:

a) Double Neck Guitar/Bass

b) A separate instrument only with the first neck

c) A separate instrument only with the second neck

The invention refers to: a) an electric guitar with 2 necks (e.g. with a twelve-string and a six-string neck) that can be divided into two separate autonomous guitars (e,g., a twelve-string and a six-string guitar) b) an electric bass with 2 necks (e.g. a fretted and a fretless neck) that can be divided into two autonomous basses (e.g. a fretted and a fretless bass) c) a combination of electric guitar and bass with 2 necks (e.g. a six-string guitar and a fretted bass) that can be divided into two separate autonomous instruments (e.g. one six-string guitar and a fretted bass). In any case, the division of the mentioned musical instruments is made possible thanks to the specially designed construction of their bodies.

Guitars/basses with 2 necks are already known. The double necks give music performers dual sound capabilities and simultaneously allow them to have a double role during the musical performance. The double neck guitars/basses are mainly intended for live performance. E.g. when a musician while playing a live track does not have the time to leave the twelve-string guitar and catch the six-string, because this would mean to stop playing at all for at least some seconds. On the contrary, when playing an instrument with 2 necks, the change from one neck to another is almost instantaneous, taking imperceptible time. However the instruments with double necks apart from their increased cost, they have also a very limited use, only for specific circumstances of live music. This is why in the majority of the musical activities of most guitarists/bassists standard single neck instruments are used, which musicians always primarily own, Thus, for any guitarist/bassist buying an instrument with double neck is a high extra cost for an instrument probably not often needed.

The advantage of this invention is the possibility of its multiple uses, since it can itself serve all possible requirements of its users in different circumstances.

The electric guitar/bass with double neck according to the present invention has the characteristic that it can be divided into individual guitars/basses which are used alternatively by the musician without the need to purchase other originally individual instruments. This is actually a “3 in 1” electric guitar bass. For example the holder of such an electric bass with two necks (fretted-fretless) of the type proposed by the invention, can easily transform it into a single fretted and a single fretless bass, depending on the circumstances and requirements of the music. This conversion is possible thanks to the divided electric guitar/bass body. So whenever the guitar/bass body splits, 2 individual autonomous instruments are created. The two autonomous instruments have of course the possibility to easily reconnect whenever musical circumstances require it, creating again the original double neck instrument.

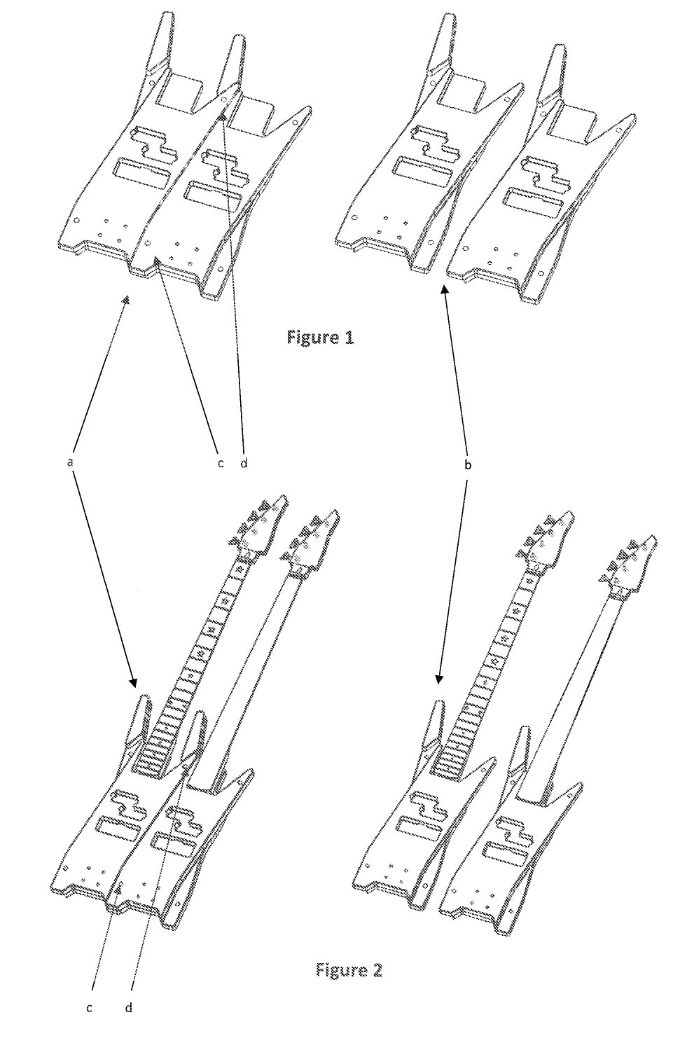

FIG. 1 shows the way the two electric guitar/bass bodies are connected for double neck use (see a) and the manner of their division (see b) from which the two autonomous instruments arise.

FIG. 2 shows the bodies of FIG. 1 combined with bass necks (fretted-fretless) and the result of their division from which a self fretted and a self fretless bass arise. FIG. 2 is only one of the possible combinations that could result by choosing each time different guitar or bass necks.

One way of implementing the invention is described with reference to the drawings. The bodies are designed and constructed so as to pair one inside the other when connected (a) as shown noticeably in the figures, while held together by screws (the screws are not shown in the drawings) that are screwed into the holes (c) and (d) as illustrated in FIGS. 1 and 2.

So whenever the division of the two bodies is needed, unscrewing the two screws suffices. When using the instrument as a double neck (a), i.e. the two bodies connected, apart from screws, other types of links (none of them are shown) could be used for inside the holes (c) and (d), such as: clips, clip shafts or even a semi locking-unlocking system (each time onto the bodies or removable).

1. The electric guitar/bass with double neck can be instantly divided, in one go, into two separate completely autonomous guitars/basses, without any further transformation or addition.

2. The electric guitar/bass with double neck, according to claim 1, is able to be
instantly divided, in one go, thanks to the specific body composed of two sub-bodies that can be paired, from both right to left or left to right sides, and are held together as one single body, by screws or clips, allowing any guitarist/bassist use it with a common typical strap when playing standing.

3. The electric guitar/bass with double neck, according to claim 1, allows the following least neck combinations possible: twelve-string guitar with six-string guitar, fretted bass with fretless bass, and guitar with bass, since its special design also easily allows further unlimited electric guitar/bass connections, letting it act as a triple neck instrument, or as an instrument with even more necks at any possible neck order.

4. The electric guitar/bass with double neck, according to claim 2, allows the following least neck combinations possible: twelve-string guitar with six-string guitar, fretted bass with fretless bass, and guitar with bass, since its special design also easily allows further unlimited electric guitar/bass connections, letting it act as a triple neck instrument, or as an instrument with even more necks at any possible neck order.
